(19) United States
(12) Patent Application Publication
(10) Pub. No.: US 2006/0267369 A1
(43) Pub. Date: Nov. 30, 2006

(54) SUN VISOR DETENT SPRING CLIP

(75) Inventors: Alex Kearns, Lake Orion, MI (US); Jeffrey M. Donovan, St. Clair Shores, MI (US); Kirk Nicola, Beverly Hills, MI (US)

Correspondence Address: Bruce E. Harang, PO BOX 872735, VANCOUVER, WA, 98687-2735, US

(73) Assignee: LEAR CORPORATION, Southfield, MI (US)

(21) Appl. No.: 10/908,487

(22) Filed: May 13, 2005

(51) Int. Cl. B60J 3/02

(52) U.S. Cl. 296/97.12

(57) ABSTRACT

An improved sunvisor spring clip for use in attaching a sunvisor to a pivot shaft by providing a generally U-shaped clip having first and second arms within a cooperating clip housing integrally formed within the rear panel of the sunvisor. A conduit is formed by the spring clip enabling the sliding of the pivot shaft into both the clip housing and the spring clip. The clip housing is designed to cooperate with the pivot shaft to pre-stress one arm of the spring clip, thereby eliminating excess play between the spring clip and the sunvisor when the visor is pivoted. The attachment mechanism is designed such that a snap-shut finger is properly received within a receiving bore, thereby effectively securing the sunvisor to the pivot shaft.

### BACKGROUND OF THE INVENTION

1. Field of the Invention

The present invention generally relates to a sunvisor spring clips and, in particular, to an improved spring clip for attaching a vehicle sunvisor to a pivot shaft.

2. Description of the Related Art

The present invention relates to automobile sunvisors, particularly to the attachment mechanism for securing a sunvisor to a pivot shaft.

Traditionally, sunvisor spring clips have been seated rather loosely within the visor body causing an undesired amount of noise in the form of clicking or snapping upon movement of the sunvisor. Numerous approaches have been taken to alleviate the problem. The most common approach involves the use of separate fasteners, such as rivets to secure the clip to the body of the visor.

For example, U.S. Pat. No. 4,428,612 issued Jan. 31, 1984 to Viertel et al teaches a swivel mount including a mount housing cooperating with a detent spring which is wrapped around a sunvisor mounting shaft for aiding in the mounting of a sunvisor body. The detent spring includes two arms which extend from the web of the spring. The detent spring is mounted on the mounting shaft with the aid of an end stop which, in combination with the arms of the detent spring, forms a clip connection. In this construction, the detent spring relies upon the interaction of both arms with the end stop to provide a secure fit. In addition, the detent spring does not include a fastening means for connecting the two arms to form a clip connection, instead relies upon one arm hooking over the end stop to form the clip connection.

U.S. Pat. No. 4,469,367 issued Sep. 04, 1984 to Kuttler teaches another clamping spring which wraps around a mounting shaft for a sunvisor. The U-shaped spring includes a web which is wrapped around the mounting shaft and arms extending from the web. The ends of the arms include an inwardly facing hook and hooking edge that are hooked together in tension during the mounting of the sunvisor. However, this design relies on close tolerances between the bottom arms of the clip and a support member between them to minimize snapping and clicking noises.

A solution to the shortcomings of these types of spring clips are spring clips having secondary locking features, such as rivets, or spring clips that are assembled closed requiring the mounting of the visor arm through a closed clip. Other sunvisor clips are reversed and apply pressure using an open design pre-loaded U-shape that is not closed around the visor arm. Still other spring clips have double detent flats on the arm at two separate locations around the arm circumference, for example 180 degrees from each other.

U.S. Pat. No. 5,139,303 issued Aug. 18, 1992 to Miller teaches a sunvisor spring clip and attachment mechanism having a housing cooperating with a spring clip to secure pivotally a sunvisor to the pivot shaft. The spring clip is seated within the housing in a manner enabling the spring clip to be pre-stressed, insuring a secure and noiseless attachment when the spring clip is in the closed position and the sunvisor is connected to the pivot shaft.

U.S. Pat. No. 5,338,083 issued Aug. 16, 1994 to Gute teaches a non-locking open U-shaped spring clip suitable for use to secure pivotally a sunvisor to the pivot shaft.

U.S. Pat. No. 5,564,772 issued Oct. 15, 1996 to Miller teaches a leaf spring type sunvisor spring clip suitable for securing a sunvisor to a sunvisor pivot arm.

U.S. Pat. No. 5,924,748 issued Jul. 20, 1999 to Zapinski teaches another non-locking U-shaped spring clip suitable for use to secure pivotally a sunvisor to a pivot shaft.

U.S. Pat. Nos. 6,722,722 and 6,830,280 issued Apr. 20, 2004 and Dec. 14, 2004 respectively to Sturt et al. teach two more leaf spring type spring clips suitable for securing pivotally a sunvisor to a pivot arm.

While these are solutions there continues to be a number of desirable features for a sunvisor spring clip not addressed.

### DISCLOSURE OF THE INVENTION

The present invention provides advantages and improvements over the prior art by providing an improved sunvisor spring clip attachable to a housing cooperating with said spring clip to pivotally secure a sunvisor to the pivot shaft. The spring clip is seated within the housing in a manner enabling the spring clip to be pre-stressed, insuring a secure and noiseless attachment when the spring clip is in the closed position and the sunvisor is connected to the pivot shaft.

According to a further aspect of the present invention, there is provided a sunvisor spring clip of one-piece design that incorporates at least two detent flats for increased detent and rotational effort.

According to yet another aspect of the present invention there is provided a sunvisor spring clip incorporating at least two relief slots on the backside of the detent clip to allow it to act in a spring-like manner in addition to acting as a friction device.

According to a yet further aspect of the present invention there is provided a sunvisor spring clip which substantially increases the surface area over which pressure is exerted on the sunvisor arm.

According to still another aspect of the present invention there is provided a sunvisor spring clip having a self-locking feature that additionally prevents the sunvisor spring clip from bending past its material yield point.

According to still yet another aspect of the present invention there is provided a sunvisor spring clip substantially increases the amount of contact area between the sunvisor arm and the sunvisor spring clip by adding a hump to the backside of the clip, combined with a longer clip length allowing more uniform loading and making it easier to tune rotational efforts.

A further aspect of the present invention provides for a spring clip for use in cooperative combination with a vehicular sunvisor having a spring clip housing portion and a boss to secure pivotally the sunvisor to a pivot arm, the spring clip comprising: a first member and a second member generally forming an integral U-shaped unit having an attachment end and a free end selectively engageable to pre-stress the spring clip and pivotally secure the sunvisor to the pivot arm; the attachment end having a locking slot for receiving and locking the free end in a closed position and preventing the spring clip from being bent past the material yield point, a generally circular hump, and a pair of mounting tabs also located on the attachment end co-operable with the clip housing portion when said spring clip is mounted in said clip housing portion of said sunvisor; and the free end having a locking tab receivable in the locking slot of said attachment end thus engaging attachment end and free end, securing said spring clip in the sunvisor, locking the sunvisor onto a pivot arm, and pre-stressing pivot arm with respect to the sunvisor to eliminate excess play between the pivot arm and the sunvisor when the sunvisor is pivoted on the pivot arm.

A still further aspect of the present invention provides for an improved attachment means for pivotally securing a vehicular sunvisor to a pivot arm, comprising: a sunvisor including a shell having joinable front and rear panels; a clip housing integrally formed with a biasing means within one panel of the sunvisor and adapted to receive the pivot arm for securing the sunvisor once the front and rear panels have been joined; a spring clip co-operating with the clip housing to provide a conduit on the sunvisor to receive the pivot arm and having a first member and a second member generally forming an integral U-shaped unit having an attachment end and a free end selectively engageable to pre-stress the spring clip and pivotally secure the sunvisor to the pivot arm; the attachment end having a locking slot for receiving and locking the free end in a closed position and preventing the spring clip from being bent past the material yield point, a generally circular hump, and a pair of mounting tabs also located on the attachment end co-operable with the clip housing portion when said spring clip is mounted in said clip housing portion of said sunvisor; and the free end having a locking tab receivable in the locking slot of said attachment end thus engaging attachment end and free end, securing said spring clip in the sunvisor, locking the sunvisor onto a pivot arm, and pre-stressing pivot arm with respect to the sunvisor to eliminate excess play between the pivot arm and the sunvisor when the sunvisor is pivoted on the pivot arm.

A yet still further aspect of the present invention provides for a method of attaching a sunvisor to a pivot arm comprising the steps of: placing a detent spring clip having a first member and a second member generally forming an integral U-shaped unit having an attachment end and a free end, the attachment end having a locking slot for receiving and locking the free end in a closed position and preventing the spring clip from being bent past the material yield point, a generally circular hump, and a pair of mounting tabs also located on the attachment end, and a free end having a locking tab receivable in the locking slot of said attachment end; mating the mounting tabs with the cooperating mounting slots by moving the detent spring clip to the upright position; forcing the detent spring clip to rest against the clip housing; sliding the pivot arm into both the housing and a conduit formed by the detent spring clip, thereby pre-stressing one member of the detent spring clip between the pivot arm and the housing and eliminating excess play between the detent spring clip and the housing; pressing the locking tab located on the free end into the locking slot located on the attachment end, ensuring the locking tab is properly located in the locking slot, thereby pre-stressing the second member against the pivot arm; and securing the sunvisor to the pivot arm while eliminating excess play between the pivot arm and the sunvisor when the sunvisor is pivoted.

The present invention thus advantageously provides an improved sunvisor spring clip which is installed open, is closed during assembly to the sunvisor arm without the need for secondary locking features, thus it does not need to be closed prior to assembly nor is it left open after assembly. It further advantageously requires at least two detent flats in parallel on one side, or two sides at any desired angle of separation if desired, of the sunvisor arm. One preferred embodiment has detent flats on the arm at two separate locations around the arm circumference, for example 180 degrees from each other.

### BRIEF DESCRIPTION OF THE DRAWINGS

FIG. 1 shows an exploded perspective view of the spring clip of the present invention and a partially broken away view of a sunvisor assembly having a cooperating spring clip housing located therein.

FIG. 2 shows a perspective view of a sunvisor assembly similar to that shown in FIG. 1, partially broken away showing the spring clip of the present invention mounted within the cooperating spring clip housing.

FIGS. 3 and 4 show end views in cross-section showing the installation of the spring clip of the present invention with the pivot arm within the sunvisor cooperating housing.

FIG. 5 shows a cross-section end view of the spring clip of the present invention and the pivot arm installed within the cooperating housing prior to snapping shut the clip.

FIG. 6 shows a cross-section end view of the spring clip of the present invention and the pivot arm installed within the cooperating housing after snapping shut the clip.

FIG. 7 shows a perspective view of the reverse side of the detent spring clip shown in FIG. 1.

FIG. 8 shows a section plan view of a sunvisor arm having three detent flats in line suitable for use with the present invention.

FIG. 9 shows a section plan view of a sunvisor arm having two pair of detent flats located 180 degrees from one another suitable for use with the present invention.

### DESCRIPTION OF THE PREFERRED EMBODIMENTS OF THE INVENTION

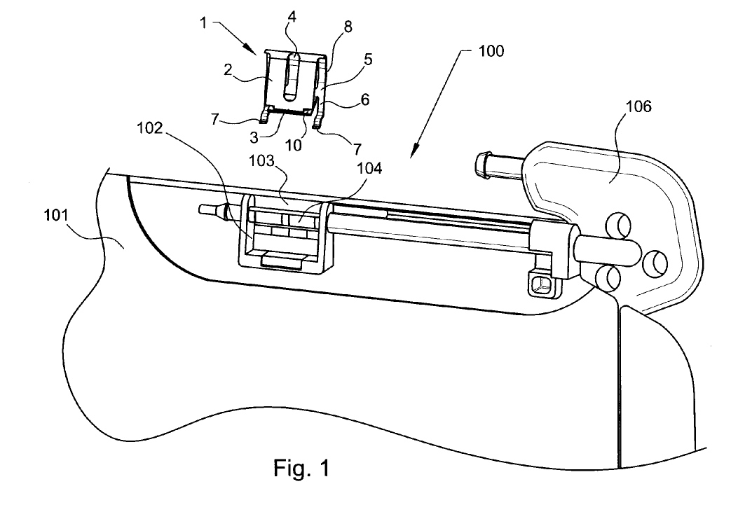

Reference will now be made to the drawings, wherein to the extent possible like reference numerals are utilized to designate like components throughout the various views. Referring to FIG. 1, there is presented an improved sunvisor detent spring clip 1 suitable for use in pivotally securing a sunvisor arm or shaft 103 to a sunvisor assembly 100 having a sunvisor 101 including a detent spring clip cooperating mounting housing 102 moveably mounted and incorporated therein, a pivot arm 103 having three detent surfaces 104, and a sunvisor mounting bracket 106.

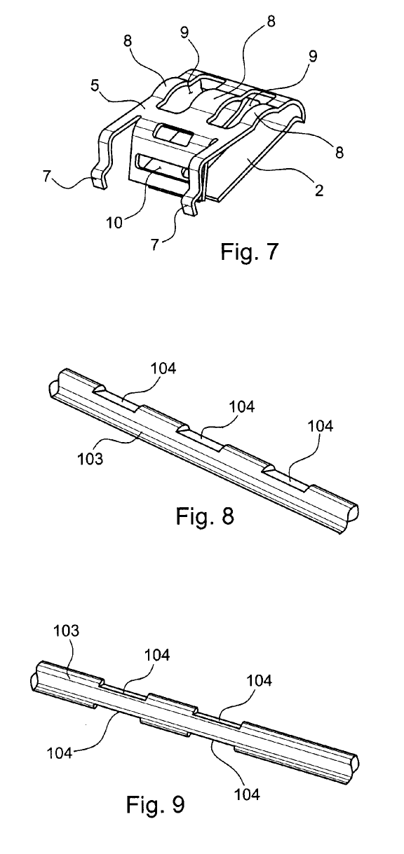

As further shown in FIG. 1 is detent spring clip 1 having a generally integral U-shape having a first member 2 and a second member 5. First member 2 having at its free end locking tab 3 and located near the U bend a relief slot 4. Second member 5 having at its free end located at each of its outer edges a tail 6 having a mounting tab 7 and located between the pair of mounting tabs 7 a locking bore 10 for receiving locking tab 3 of first member 2, as well hump 8 and at least two relief slots 9 (shown in FIG. 7). The locking tab 3 mating with locking bore 10 to lock the spring clip 1 in a closed position.

Hump 8 provides for substantially increased contact area between the spring clip 1 and the pivot arm 103 over prior spring clips providing more uniform loading thereby making the sunvisor assembly more robust and tuning of the rotational effort much easier. In addition, the increased contact area provided by hump 8 allows for greater design ability for depth of detent flats, pivot arm diameter, and spring clip gage and material selection parameters. The relief slot 4 and the at least two relief slots 9 provide the ability for the sunvisor spring clip 1 to perform simultaneously as both a spring and a friction devise thereby allowing for a simple locking means as well as providing the friction desired to allow the sunvisor to remain where positioned. The locking tab 3 and locking bore 10 provides for a self-locking feature as well as a means of preventing the clip from being closed past its material yield point.

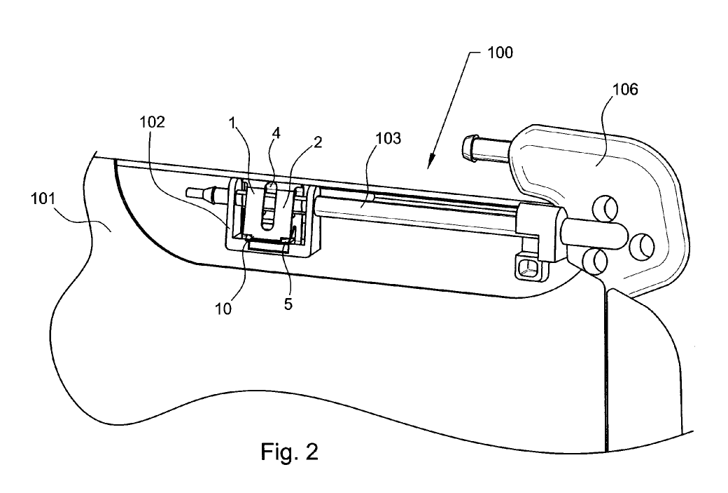

Referring now to FIG. 2, there is shown the detent spring clip 1 mounted within the cooperating housing 102 molded as an integral part of sunvisor 101 of sunvisor assembly 100 and locked around the pivot arm 103 by tab 3 (FIG. 1) being secured within locking bore 10. Also shown is first member 2 having relief slot 4, and second member 5.

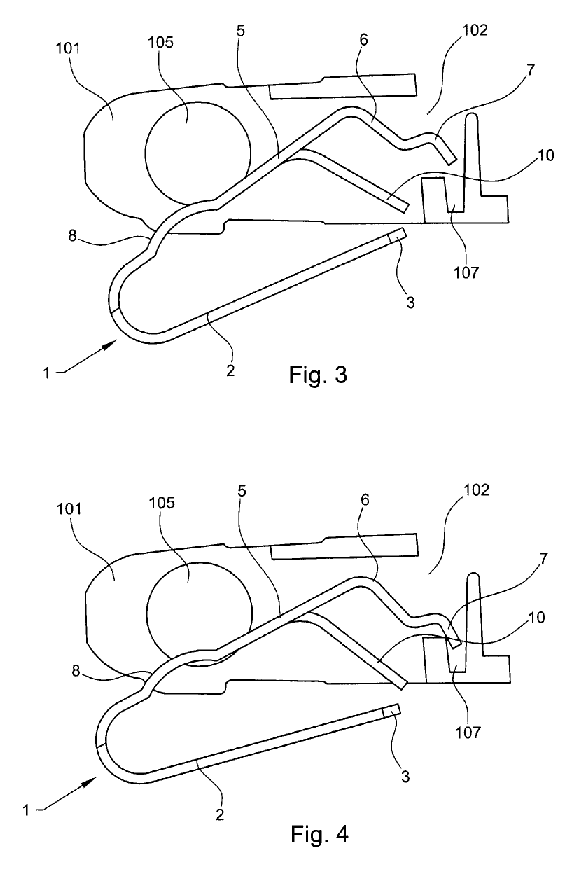

Turning now to FIGS. 3, 4, 5, and 6, there is shown the mounting of the detent spring clip 1 in the cooperating housing 102 of sunvisor 101, and the mounting and pivotally locking in place the pivot arm 103 (shown in FIG. 6). Also shown is the first member 2 having locking tab 3 and the second member 5 having tails 6 with mounting tabs 7 and locking bore 10. The sunvisor 101 shows the cooperating detent spring clip housing 102 having mounting channels 107 and sunvisor pivot arm mounting bore 105 and sunvisor pivot arm 103 mounted therein (shown in FIG. 6).

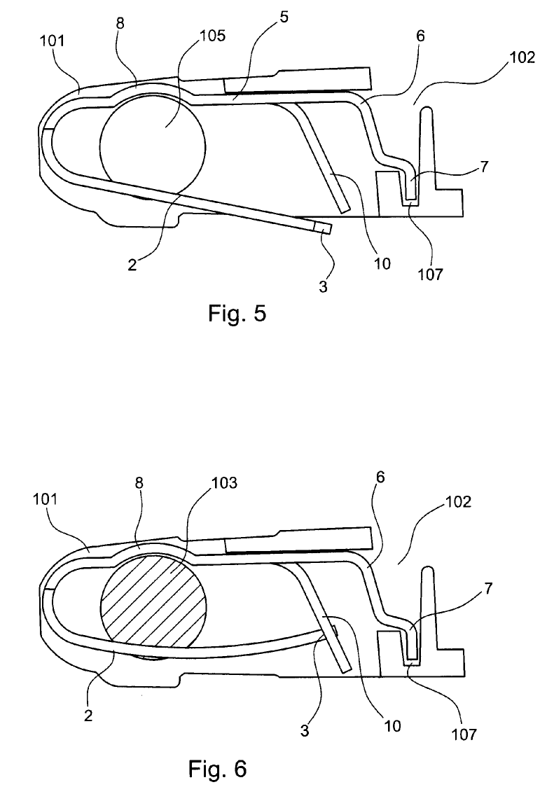

To install a sunvisor 101 using the detent spring clip 1 requires that the spring clip 1 be tipped such that the tails 6 are angled slightly (as shown in FIG. 3) enabling the mounting tabs 7 to fit within mounting channels 107 of housing 102. The spring clip 1 is then pivoted into the housing 102 such that the mounting tabs 7 mate with mounting channels 107 (as shown in FIG. 4) and the members 2 and 5 straddle the pivot arm mounting bore 105 (as shown in FIG. 5). The sun visor pivot arm 103 is then inserted into pivot arm mounting bore 105 and through the spring clip 1, and the members 2 and 5 of said spring clip 1 are locked in a closed position around said sunvisor pivot arm 103 (shown in FIG. 6).

FIG. 7 shows the reverse of the sunvisor detent spring clip 1 of the present invention as shown in FIG. 1 showing members 2 and 5, mounting tabs 7, locking bore 10, two relief slots 9, as well as hump 8.

FIG. 8 shows a partial view of a sunvisor arm suitable for use with the present invention having a arm 103 and having three detent flats 104 located in line long the arm horizontal axis.

Finally, FIG. 9 shows a partial view of a sunvisor arm suitable for use with the present invention having an arm 103 and having two pair of detent flats 104 each pair 180 degrees apart. It is to be understood that the two pair of detent flats may be located at any desired locations around the sunvisor arm circumference.

The detent spring clip of the present invention allows for the use of a wider range of pivot arm diameters than previous detent spring clips handle. Furthermore, the detent spring clip of the present invention in providing a substantially larger surface contact area with the pivot arm provides for greater control of the rotational force necessary to move the sunvisor on the pivot arm. The detent spring of the present invention also allows the use of a pivot arm having at least two detent flats all located along the same position on the pivot arm.

Although the preferred embodiments of the present invention has been disclosed, various changes and modifications may be made without departing from the scope of the invention as set forth in the appended claims.

What is claimed is:

1. A spring clip for use in cooperative combination with a vehicular sunvisor having a spring clip housing portion and a boss to secure pivotally the sunvisor to a pivot arm, the spring clip comprising:
a first member and a second member generally forming an integral U-shaped unit having an attachment end and a free end selectively engageable to pre-stress the spring clip and pivotally secure the sunvisor to the pivot arm; the attachment end having a locking slot for receiving and locking the free end in a closed position and preventing the spring clip from being bent past the material yield point, a generally circular hump, and a pair of mounting tabs also located on the attachment end co-operable with the clip housing portion when said spring clip is mounted in said clip housing portion of said sunvisor; and
the free end having a locking tab receivable in the locking slot of said attachment end thus engaging attachment end and free end, securing said spring clip in the sunvisor, locking the sunvisor onto a pivot arm, and pre-stressing pivot arm with respect to the sunvisor to eliminate excess play between the pivot arm and the sunvisor when the sunvisor is pivoted on the pivot arm.

2. The spring clip as claimed in claim 1 wherein, the spring clip further comprises a flexible material enabling pivotal rotation while securely fastening the sunvisor on the pivot arm.

3. The spring clip as claimed in claim 2 wherein, said flexible material is spring steel.

4. The spring clip as claimed in claim 1 wherein, the spring clip is shaped to accept the pivot arm having a generally circular shape and having at least two flat sides in line with one another providing a single detent position for the visor.

5. The spring clip as claimed in claim 1 wherein, the spring clip is shaped to accept the pivot arm having a generally circular shape and having at least two flat sides located at desired positions on the circumference of said pivot arm providing at least two detent positions for the visor.

6. The spring clip as claimed in claim 1 wherein, the spring clip is shaped to accept the pivot arm having a generally circular shape and having at least two flat sides 180 degrees from one another providing at least two detent positions for the visor.

7. The spring clip as claimed in claim 1 wherein, the hump has a generally circular shape dimensioned to seat the pivot arm.

8. The spring clip as claimed in claim 1 wherein, the surface areas of the spring clip contacting the pivot arm and the size of the relief slots are selected providing a desired frictional force upon the pivot arm.

9. The spring clip as claimed in claim 1 wherein, said spring clip mounts in a spring clip housing being an integral part of said sunvisor.

10. The spring clip as claimed in claim 1 wherein, said spring clip mounts in a spring clip housing being a separate part moveably mounted in said sunvisor.

11. An improved attachment means for pivotally securing a vehicular sunvisor to a pivot arm, comprising:
a sunvisor including a shell having joinable front and rear panels;
a clip housing formed with a biasing means and located within one panel of the sunvisor and adapted to receive the pivot arm for securing the sunvisor once the front and rear panels have been joined;
a spring clip co-operating with the clip housing to provide a conduit on the sunvisor to receive the pivot arm and having a first member and a second member generally forming an integral U-shaped unit having an attachment
end and a free end selectively engageable to pre-stress the spring clip and pivotally secure the sunvisor to the pivot arm; the attachment end having a
locking slot for receiving and locking the free end in a closed position and preventing the spring clip from being bent past the material yield point, a generally circular hump, and a pair of mounting tabs also located on the attachment end co-operable with the clip housing portion when said spring
clip is mounted in said clip housing portion of said sunvisor; and
the free end having a locking tab receivable in the locking slot of said attachment end thus engaging attachment end and free end, securing said spring clip in the sunvisor, locking the sunvisor onto a pivot arm, and pre-stressing pivot arm with respect to the sunvisor to eliminate excess play between the pivot arm and the sunvisor when the sunvisor is pivoted on the pivot arm.

12. The spring clip as claimed in claim 11 wherein, the spring clip further comprises a flexible material enabling pivotal rotation while securely fastening the sunvisor on the pivot arm.

13. The spring clip as claimed in claim 12 wherein, said flexible material is spring steel.

14. The spring clip as claimed in claim 11 wherein, the spring clip is shaped to accept the pivot arm having a generally circular shape and having at least two flat sides in line with one another providing a single detent position for the visor.

15. The spring clip as claimed in claim 11 wherein, the spring clip is shaped to accept the pivot arm having a generally circular shape and having at least two flat sides located at desired positions on the circumference of said pivot arm providing at least two detent positions for the visor.

16. The spring clip as claimed in claim 11 wherein, the spring clip is shaped to accept the pivot arm having a generally circular shape and having at least two flat sides 180 degrees from one another providing at least two detent positions for the visor.

17. The spring clip as claimed in claim 10 wherein, the hump has a generally circular shape dimensioned to seat the pivot arm.

18. The spring clip as claimed in claim 10 wherein, the surface areas of the spring clip contacting the pivot arm and the size of the relief slots are selected providing a desired frictional force upon the pivot arm.

19. A method of attaching a sunvisor to a pivot arm comprising the steps of:
placing a detent spring clip having a first member and a second member generally forming an integral U-shaped unit having an attachment end and a free end, the attachment end having a locking slot for receiving and locking the
free end in a closed position and preventing the spring clip from being
bent past the material yield point, a generally circular hump, and a pair of mounting tabs also located on the attachment end, and a free end having a locking tab receivable in the locking slot of said attachment end;
mating the mounting tabs with the cooperating mounting slots by moving the detent spring clip to the upright position;
forcing the detent spring clip to rest against the clip housing;
sliding the pivot arm into both the housing and a conduit formed by the detent spring clip, thereby pre-stressing one member of the detent spring clip between the pivot arm and the housing and eliminating excess play
between the detent spring clip and the housing;
pressing the locking tab located on the free end into the locking slot located on the attachment end, ensuring the locking tab is properly located in the locking slot, thereby pre-stressing the second member against the pivot arm; and
securing the sunvisor to the pivot arm while eliminating excess play between the pivot arm and the sunvisor when the sunvisor is pivoted.
